(19) United States
(12) Patent Application Publication
(10) Pub. No.: US 2009/0139935 A1
(43) Pub. Date: Jun. 4, 2009

(54) Ballast Tank Circulation Management System

(75) Inventors: Rudolf Matousek, Sugarland, TX (US); Harold E. Childers, II, Houston, TX (US); Earl Ahrens, Rancho Palos Verdes, CA (US); Julian Routh, West Midlands (GB)

Correspondence Address: Jo Katherine D'Ambrosio;D'Ambrosio & Associates, P.L.L.C., Ste. 465, 10260 Westheimer Road, Houston, TX, 77042, US

(73) Assignee: SEVERN TRENT WATER PURIFICATION, INC., Fort Washington, PA (US)

(21) Appl. No.: 12/347,004

(22) Filed: Dec. 31, 2008

Related U.S. Application Data
(62) Division of application No. 11/809,863, filed on Jun. 1, 2007.
Application No. 11/809,863 is a continuation-in-part of application No. 11/704,531, filed on Feb. 9, 2007.
(60) Provisional application No. 60/773,571, filed on Feb. 15, 2006.

(51) Int. Cl. C02F 1/76

(52) U.S. Cl. 210/744

(57) ABSTRACT

A method for managing ballast tank circulation system comprising a means for adding one or more halogens in controlled amounts to the water within the ballast tank. Test streams of water from the ballast tank can be analyzed to determine the level of halogens in the test stream to provide a halogen content signal. A controller receives the signal and compares the signal to a set point indicative of the level of halogen desired within the ballast tank to maintain, increase, or decrease the amount of chemical added to the water within the ballast tank in controlled amounts.

### CROSS REFERENCE TO RELATED APPLICATIONS

This application is a divisional application of prior U.S. application Ser. No. 11/809,863 filed Jun. 1, 2007, which is a continuation-in-part of U.S. patent application Ser. No. 11/704,531 filed Feb. 9, 2007, which claims priority to U.S. patent application Ser. No. 11/037,642 filed Jan. 8, 2005, and the benefit of Provisional Application U.S. Ser. No. 60/773,571, filed Feb. 15, 2006.

### FIELD OF THE INVENTION

The present invention relates to a ballast tank circulation management method, more particularly to a system and method for controlling the levels of marine species and pathogenic bacteria within the ballast tank.

### BACKGROUND

Water-containing ballast tanks require management of microbes and biological matter to ensure the quality water is maintained as marine vessels travel from one port to another. Releasing the ballast water taken aboard from a distant location can be both harmful to the environment and dangerous to human and animals in a new port. The introduction of non-native marine life into a new ecosystem can have a devastating effect on the native flora and fauna which may not have natural defenses to the new species. Additionally, harmful bacterial pathogens, such as cholera, may be present in the origination port. These pathogens can multiply in the ballast tanks over time and cause an outbreak of illness in the area where they are released. The dangers posed by the marine life and pathogens may be controlled by killing those species present in the ballast water.

### SUMMARY

For the past century, chlorination has become the standard way to disinfect water supplies, potable water, wastewater and swimming pools, for example, to eliminate epidemics of waterborne diseases. Stagnation and stratification can occur because of the limited area, below and above the surface, that is circulated by existing ballast tank circulation methods. Circulation of water and added chemicals throughout the ballast tank is spotty and limited, resulting in inconsistent water quality.

As a consequence of the limitations of the existing methods, there is a need for an improved method for managing the water contained in a ballast tank to ensure the ballast water taken aboard from a distant location is not harmful to the environment nor dangerous to human and animals in a new port.

The present invention is directed towards method for managing ballast tank circulation. In one embodiment, the method comprises treating the water within the ballast tank by adding one or more chemicals in controlled amounts, the ballast tank adapted to comprise inlet and outlet piping. In this embodiment, the method further comprises recirculating and pressurizing water throughout the ballast tank by means of a recirculating pump located external to the ballast tank, an inlet line to the recirculating pump tapping into the outlet pipe of the ballast tank to transport water to the recirculating pump and an outlet line from the recirculating pump to the ballast tank transports a high pressure stream of water from the pump to a location approximate the eductor. The method also comprises positioning one or more eductors within the ballast tank above the pressurized stream of water, the one or more eductors designed to receive a pressurized stream of water from the external circulating pump and emit a jet of highly pressurized water to circulate the one or more chemicals throughout the ballast tank. Next, the method comprises sampling a test stream of water from the ballast tank by removing a test sample through a sample line. The test stream is analyzed, and a chemical-related signal is sent to a controller to compare the signal to a set point indicative of the level of chemical desired within the ballast tank. In this embodiment, the method also comprises adding one or more chemicals as determined by the comparison of the signal to the set point. The level of the one or more chemicals within the ballast tank may be controlled by maintaining, increasing or decreasing the amount of chemical added to a dosing line leading from a chemical generator to the ballast tank system.

The method for managing ballast tank circulation also comprises a ballast tank circulation method for controlling and circulating halogens within ballast tanks to maximize disinfection of the ballast water. This invention comprises an external pump assembly to facilitate the maintenance and repair of the ballast tank system. The pump is hooked up outside of the ballast tank with two connections thereby simplifying installation and repairs, and the repairs to the pump can be facilitated without emptying the water from the tank. One embodiment of the present invention comprises a ballast tank circulation system and an external pump assembly. The system comprises inlet and outlet piping and means for adding chemicals in controlled amounts to the water within the ballast tank.

The system further comprises one or more eductors positioned within the ballast tank to mix and circulate the water within the tank. A recirculating pump is located externally to the ballast tank and has an inlet line that taps into the outlet piping from the ballast tank. The recirculating pump along with the eductor pressurizes and recirculates the water throughout the ballast tank. The recirculating pump discharges a pressurized stream of water and ingests water at a point remote from the discharging. The recirculating pump comprises an inlet line leading from the ballast tank to the pump and an outlet line from the pump leading to inlet pipe of the ballast tank. The inlet line taps in to the outlet pipe of the ballast water tank to pipe and transport water from the ballast tank to the recirculating pump. The recirculating pump pressurizes the water and the outlet line transports the highly pressurized stream of water from the recirculating pump back to the ballast tank. An eductor is positioned within the ballast water tank adjacent the inlet pipe as it enters the ballast tank to receive the pressurized stream of water discharged from the pump. The eductor pulls more liquid through to enhance the flow rate and emits a higher pressure jet of water into the ballast tank to circulate the halogens within the ballast water.

In one embodiment, one or more sample lines remove test streams of water from the ballast tank which are then analyzed to measure the chemical content in the test stream to provide a chemical-related signal. A controller receives the signal and compares the signal to a set point indicative of the level of halogen desired within the ballast tank. The controller maintains, increases, or decreases the amount of halogen added to the water within the ballast tank in controlled amounts.

In one or more embodiments, the external recirculating pump can be located adjacent one side of the ballast tank, on top of a cover of the ballast tank or on a floatation device floating on top of the water within the ballast tank. Alternatively, the recirculating pump is located adjacent the base of the ballast tank. The eductor can be adapted for positioning adjacent the inlet piping within the ballast tank or movable throughout the ballast tank. Chemicals added to the ballast tank include at least one of ammonia, hypochlorite, chlorine and bromine. The chemical reactions that occur during the production of hypochlorite and the use of it as a disinfectant may result in several forms of chlorine that are active at different times. For example, the chlorine ions found from the hypochlorite produce hypochlorous acid when the hypochlorite is added to saline water. For simplicity, all forms of chlorine occurring during the various reactions that take place in the practice of the method of this invention will be referred to as halogen content, including the formation of chloramines when ammonia combines with the halogens. A hypochlorite generator can be used to produce hypochlorite to add to the ballast water. A chemical dosing system provides a controlled source of required halogen for addition to the ballast tank according to a signal emitted by the controller. In one aspect, the chemical dosing system is a halogen dosing system comprising a hypochlorite generator and a hypochlorite storage tank. In another embodiment, the halogen dosing system comprises a pump for pumping the produced halogen to the ballast tank and a hypochlorite outlet line to take the produced halogen to the ballast tank. In yet another embodiment, the hypochlorite is generated external to the system and can be pumped directly into the ballast tank.

In one aspect, a chemical dosing line transports halogen to the ballast tank for dosing the ballast water. An outlet line extends from the recirculating pump to the ballast tank and the chemical dosing line is tapped into the outlet line. Alternatively, the chemical dosing line transports halogens directly from the chemical dosing system to the ballast tank. The sample line taps into the recirculating pump outlet line to carry the test stream of water to the analyzer. Alternatively, the sample line connects the analyzer to the ballast tank to carry the test stream of water from the ballast tank directly to the analyzer. In one embodiment, the analyzer determines the level of chemicals in the test stream to provide a chemical-related signal. This chemical-related signal may in some embodiments indicate the need for pH control additives, disinfectants other then ammonia and chlorine derivatives, fluorides and phosphates. In one embodiment, the analyzer determines the level of total chlorine equivalents in the test stream to provide a chlorine related signal. The controller receives the signal and compares the signal to a set point indicative of the level of chlorine or chlorine equivalent desired within the ballast tank. The controller is designed to maintain, increase, or decrease the amount of ammonia, hypochlorite or chlorine added to the water within the ballast tank. One aspect of an embodiment comprises means for adding chemicals in controlled amounts to the water within the ballast tank. A chemical dosing system provides a controlled source of ammonia, hypochlorite and chlorine for addition to the ballast tank according to a signal emitted by the controller.

One method for managing ballast tank circulation comprises recirculating pressurized water throughout the ballast tank by means of a recirculating pump located external to the ballast tank. One or more eductors are positioned within the ballast tank circulation above the inlet of the pressurized water coming from the external recirculating pump. The one or more eductors are designed to mix and circulate water within the ballast tank to disperse the chemicals and avoid temperature gradients. Water is recirculated throughout the ballast tank by the pressurized water coming from the external recirculating pump. An inlet line to the recirculating pump is tapped into the outlet pipe of the ballast tank to bring water to the external pump. The outlet line from the recirculating pump transports high pressure water from the pump to a location approximate the eductor. The ejector draws in the pressurized water and emits a jet stream which circulates chemicals, specifically the halogens, throughout the ballast water tank.

In one aspect of the method of this invention, a test stream of water from the ballast tank is sampled by removing the test sample through a sample line. The level of at least one of the chemicals in the test stream is analyzed to provide a signal, and the signal is then sent to a controller to compare the signal to a set point indicative of the level of halogen desired within the ballast tank. The controller then determines the type and amount of chemical required to be added to the ballast tank. In one embodiment, the step of analyzing the chemical content in the test stream comprises analyzing the chlorine ion content within the ballast water. Alternatively, the step of analyzing the test stream of water comprises determining the oxidation/reduction potential of the ballast water. In another embodiment, the method comprises measuring the total organic carbon content of the ballast water to identify oxidant content.

One or more chemicals as determined during the analysis are then added to the ballast tank. The level of the one or more chemicals within the ballast tank is controlled by maintaining, increasing, or decreasing the amount of chemical added to the chemical dosing line. The chemicals added to the ballast tank can also comprise pH control additives, disinfectants other then ammonia and chlorine derivatives, fluorides and phosphates.

### DRAWINGS

FIG. 1 is one embodiment of the Ballast tank circulation system showing a pump on one side of a ballast tank.

FIG. 2 illustrates the ballast tank circulation method comprising a pump on top of a ballast tank cover.

FIG. 3 shows another embodiment of the ballast tank circulation method comprising an ORP analyzer.

### DETAILED DESCRIPTION

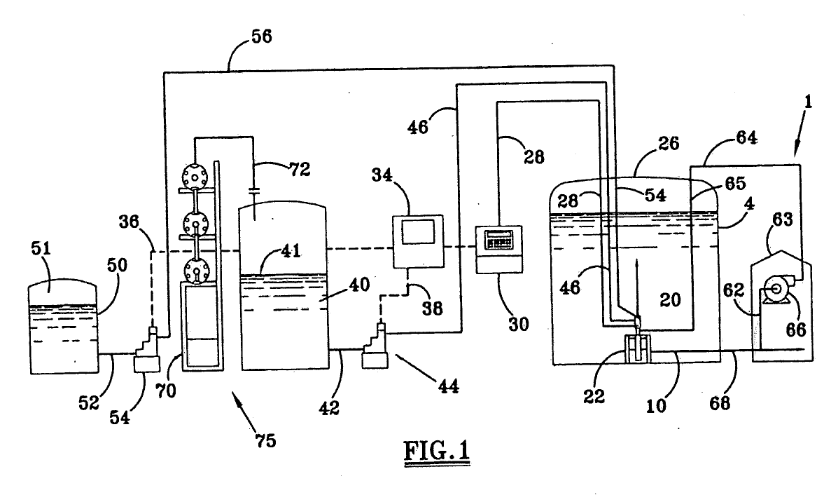

FIG. 1 of the present invention illustrates a ballast tank circulation system 1 for one or more water storage and treatment ballast tanks 10 having a pump 66 that is external to the ballast tank 10. The external pump 66 facilitates management and repair of the ballast tank system 1. One embodiment of this invention requires two connections to hook up the pump system 66. The ballast tank circulation system 1 also comprises one or more eductors 20 positioned within the ballast tank 10 so that the eductor 20 receives pressurized water from the external pump 66 and emits the water as a highly pressurized jet stream. An eductor is used to enhance water motive force, and consequently, the recirculation of water and chemicals within the ballast water. As the eductor pulls in the pressurized water coming from the external pump 66, it also pulls in ballast water in the tank that is in the surrounding area of the eductor 20. The jet stream sprouting from the eductor 20 circulates the ballast water and, therefore, the chemical disinfectants within it throughout the ballast tank 10. The halogen-based chemical disinfectants can include chlorine, hypochlorite and bromine. The improved circulation of the halogens improves the disinfection of the ballast water prior to release in a new port.

As shown in FIG. 1, in one embodiment of a ballast tank circulation system 1, the ballast tank 10 has a combined inlet/outlet pipe 68 serving two functions for loading ballast and unloading ballast. The ballast water enters and leaves the ballast tank 10 through that one pipe 68. Additional inlet or outlet piping may be used when required. The ballast tank circulation system 1 has a means for adding chemicals in controlled amounts to the water within the ballast tank 10. FIG. 1 illustrates one embodiment of the chemical supply systems. Various chemical supply systems can be used including, but not limited to, the supply units illustrated. FIG. 1 shows an ammonia chemical supply system and a hypochlorite chemical supply system. Ammonia 51 is stored in an ammonia storage tank 50 and removed through an ammonia pump inlet piping 52. FIG. 1 also shows one means of adding one or more halogens, specifically, a hypochlorite generator 70, which releases hypochlorite 41 through a hypochlorite generator outlet piping 72, a hypochlorite outlet line 56 so that the hypochlorite 41 can be sent directly to the ballast tank 10 or stored in a hypochlorite storage tank 40. The hypochlorite 41 is removed from the hypochlorite storage tank 40 through the hypochlorite pump inlet piping 42. A Chiller Tank can be used to chill and store ammonia. Chlorine generators as well as supply systems for other required chemicals can be included as part of the ballast tank circulation system 1. In addition to ammonia, hypochlorite and chlorine, the other chemicals comprise pH control additives, additional disinfectants, fluorides, and phosphates can be used for water treatment.

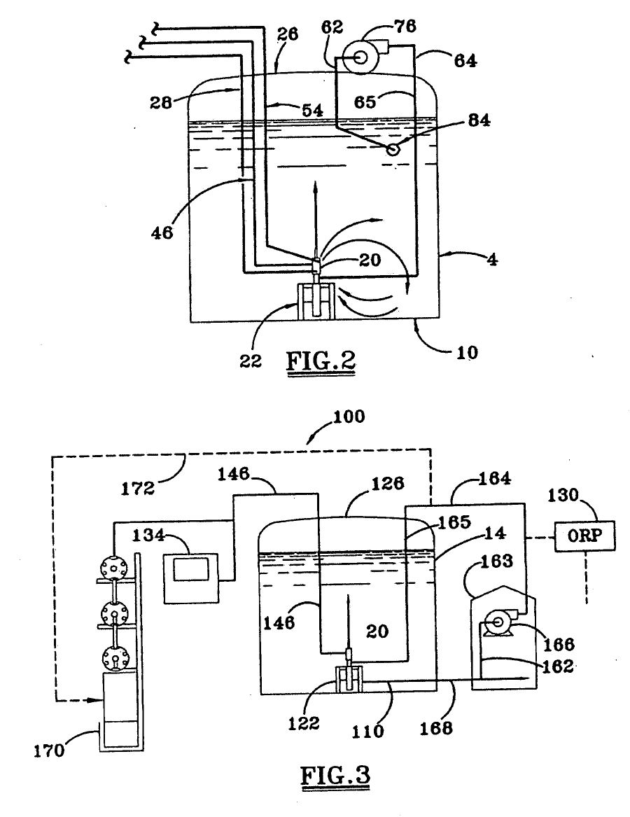

Ballast tanks range in size from small tanks holding less than 10,000 gallons to large ballast tanks having upward of 5,000,000 gallon capacities. Both larger ballast tanks and sometimes smaller ballast tanks having a slow rate of influent have areas within the ballast tank where stagnation and temperature gradients can occur. To reduce stagnation and temperature gradients, one or more eductors 20 or flow inducers are positioned within the ballast tank 10 circulation system 1. The one or more eductors 20 are designed to mix and circulate water to reduce stagnation and mix the chemicals as they are added to the ballast tank 10. In one embodiment of this invention, the eductor 20 is stationary and positioned adjacent the inlet piping 68 to the ballast tank 10 so that influent streams are mixed with chemicals as they are introduced into the ballast tank 10. The stationary eductor 20 can be attached to a pole and lowered into the ballast tank 10. Alternatively, the one or more eductors 20 are movable within the ballast tank 10 to mix and circulate water, especially within larger ballast tank systems 1. As shown in FIG. 1 and FIG. 2, a submersible buoyancy system 22, such as available from Severn Trent Systems—Water Purification division, can be used for moving eductors 20 throughout the ballast tank 10.

In another embodiment of this invention, the educator 20 is positioned within the jet of pressurized water discharged from the pump 66. With the external recirculating pump 66, the pump is located outside of the ballast tank 10 and can be positioned adjacent one side 4 of the ballast tank 10 (FIG. 1) or near the ballast tank top 26. Various locations include on top of a cover of the ballast tank 76 (FIG. 2), which in marine vessels can be the deck of the ship.

In one aspect of the invention, the external recirculating pump has an inlet line 62 bringing water from the ballast tank 10 into the pump and an outlet line 64 for transporting water under pressure from the pump 66 back to the ballast tank 10. In one embodiment of the invention as shown in FIG. 1, the inlet line 62 taps into the combined inlet/outlet piping 68 from the ballast tank 10 so that a partial amount of the treated water leaving the ballast tank 10 is sent to the pump to be pressurized and re-circulated back into the ballast tank 10. The outlet line 64 leads from the recirculating pump to a position approximate the eductor 20 so that treated water from the pump is ingested by the eductor 20 and re-circulated within the ballast tank 10. In an alternative embodiment of the invention, shown in FIG. 2, the inlet line 62 taps into a suction pipe 84 located within the ballast tank 10.

In one aspect of this invention, as shown in FIG. 1, a sample line 28 can be used to remove a test stream of water from the ballast tank 10 and send it to an analyzer 30. The sample line 28 can tap into the pump outlet line 64 and carry the previously treated water to an analyzer 30. In an alternative system, the sample line 28 can be positioned above the one or more eductors 20 within the ballast tank 10 to transmit the treated water to the analyzer 30 so that the analyzer 30 determines the make-up of the treated water. The analyzer 30 determines the level of at least one of the chemicals in the test stream and emits a chemical-related signal. In the system for managing ballast tank circulation 1, an analyzer for measuring the halogen requirement level is selected from a group of analyzers including a chlorine ion analyzer to measure the level of chlorine ions within the ballast water, an oxidation/reduction potential analyzer for determining the oxidation/reduction potential of the ballast water and a total organic carbon analyzer for measuring total organic carbon content of the ballast water.

The analyzer 30 can determine the levels of multiple chemicals and emit multiple signals to a controller 34. The controller 34 receives the signal and compares the signal to a set point indicative of the level of chemical desired within the ballast tank 10. The controller 34 is designed to maintain, increase, or decrease the amounts of chemical added to the water within the ballast tank 10 in controlled amounts. In one embodiment of the invention as shown in FIG. 1, the controller 34 emits a halogen content signal to the hypochlorite dosing system 75 to provide the required amount of halogen to the ballast tank 10. The hypochlorite dosing system 75 comprises a hypochlorite pump 44 and a hypochlorite dosing line 46 leading to the ballast tank 10. The controller 34 can also emit an ammonia signal 36 to an ammonia dosing system 55 to produce the required amount of ammonia. The ammonia dosing system comprises an ammonia pump 54 and an ammonia dosing line 56 leading to the ballast tank 10.

Various chemicals and additives are required to treat and maintain the water within the ballast tank 10. Some of the more common chemicals added to the ballast tank 10 are at least one of ammonia, hypochlorite, and chlorine. Other chemicals added to the ballast tank 10 comprise pH control additives and additional disinfectants. One or more chemical dosing systems provide a controlled source of the one or more required chemicals for addition to the ballast tank 10 according to the signals emitted by the controller. Some chemicals can be manufactured on site, such as chlorine produced by hypochlorite generators, and either used immediately or stored for future use.

Others are transported to the ballast tank area and stored in tanks. One or more chemical dosing lines transport chemicals from the storage tanks to the ballast tank 10. Alternatively, as seen in FIG. 1, the ammonia dosing line 56 and the hypochlorite dosing line 46 transport chemicals directly from the ammonia pump 54 and hypochlorite pump 44, respectively, to the ballast tank 10. In either embodiment, the chemicals to be dosed enter the ballast tank 10 approximate the eductor 20 so that the jet stream exiting from the eductor 20 mixes with the chemicals and provides good circulation of the chemicals within the ballast tank water.

FIG. 3 illustrates another embodiment of the ballast water tank circulation system 100. The system 100 comprises a ballast tank 110, a hypochlorite generator 170, an analyzer 130, a controller 134, a pump 166 external to the ballast tank 110 and an eductor 120 within the ballast tank 110. In this embodiment, the ballast tank 110 comprises an inlet piping 165 and an outlet piping 168. The ballast tank 110 contains saline water, typically sea water taken in from one port with marine life indigenous to that port. Prior to entering a new port, the ballast water must be disinfected of marine organisms that may be harmful to the balance of organisms in the new port. To that end, the hypochlorite generator 170 produces the halogens to add to water within the ballast tank 110 to kill off biological species. Water needed by the hypochlorite generator can be drawn off from the external pump outlet line 164. The hypochlorite generator outlet line 146 transports the halogens to the ballast tank 110 to a point adjacent one or more eductors 120 within the ballast tank 110. The one or more eductors 120 are designed to mix and circulate water within the ballast tank 110 thereby circulating the halogens and other chemicals within the tank 110.

A recirculating pump 166 located externally to the ballast tank 110 discharges a pressurized stream of water as water, ingested at a point remote from the discharging, flows through it. The recirculating pump 166 comprises an inlet line 162 from the outlet pipe 168 of the ballast tank 110 and an outlet line 164 leading back to the ballast tank 110. The outline line 164 enters the ballast tank 110 and becomes an inlet pipe 165 leading to the eductor 120. The eductor 120 is positioned adjacent the inlet pipe 165 as it enters the ballast tank 110 to receive the pressurized stream of water discharged from the external recirculating pump 166.

To control the amount of halogen within the ballast tank 110, the halogen content must be measured, compared to a required level for effective disinfection and then increased, if necessary. An oxidation/reduction potential analyzer 130 is connected to the outlet line 164 for determining the halogen requirement level in the water discharged from the pump 166. If additional halogen is needed, the analyzer 130 emits a halogen requirement signal. The controller 134 is designed to receive the halogen requirement signal and compare the signal to a set point indicative of the level of halogen desired within the ballast tank 110. The controller 134 maintains, increases, or decreases the amount of halogen added to the water within the ballast tank 110 in controlled manner that is responsive to the signal produced by the analyzer 130. The hypochlorite dosing system then provides the required halogen, in lesser or greater amounts, to the ballast tank 110 in response to the signal emitted by the controller 134.

The present invention also relates to a method for managing ballast tank circulation. During the method, water within the ballast tank 10 is treated by adding chemicals in the halogen family in controlled amounts. Referring to FIG. 4, the ballast tank 10 is adapted to comprise inlet and outlet piping 64. A recirculating pump 66 located external to the ballast tank 10, recirculates and pressurizes water throughout the ballast tank 10. An inlet line 62 to the recirculating pump 66 taps into the outlet pipe 64 of the ballast tank 10 to transport water to the recirculating pump 66 and an outlet line 64 from the recirculating pump 66 to the ballast tank 10 transports a high pressure stream of water from the pump 66 to a location approximate the eductor 20.

One or more eductors 20 or flow inducers are positioned within the ballast tank 10 to mix and circulate water so as to disperse the chemicals entering into the ballast tank 10 and provide a homogeneous mixture of chemicals and ballast water. The one or more eductors 20 are positioned to receive and draw in the pressure stream of water coming from the recirculating pump 66. As the water is drawn through the eductor 20, it produces a jet stream that circulates the halogens throughout the ballast tank 10. The external recirculating pump 66 can be positioned at various points outside of the ballast tank 10 depending on the site location. It can be on a side of the ballast tank 10 or on top.

Because the recirculating pump 66 is external to the ballast tank 10, an inlet line 62 to the recirculating pump 66 is tapped into the outlet line 64 of the ballast tank 10 and an outlet line 64 between the recirculating pump 66 and the ballast tank 10 is used for transporting high pressure water from the pump 66 to a location approximate the eductor 20. During this method, a test stream of water from the ballast tank 10 is sampled by first removing a test sample through a sample line 28. The halogen content in the sampled test stream is analyzed and a halogen-related signal regarding the level of halogen within the ballast tank 10 is generated. The halogen-related signal is then sent to a controller 34 and the signal is compared to a set point indicative of the level of halogen desired within the ballast tank 10.

The type and amount of halogen, chlorine or bromine for example, required to be added to the ballast tank 10 is measured and one or more halogens are added to the ballast tank 10. One or more chemical dosing lines, for example the embodiment of a hypochloritre dosing line 46 as shown in FIG. 4, transport additional halogen directly from the chemical dosing system to the ballast tank 10. In this way, the level of the one or more halogens within the ballast tank 10 is controlled by maintaining, increasing, or decreasing the amount of halogens added to a dosing line leading from a halogen generator to the ballast tank 10.

During the method of this invention, analyzing the chemical content in the test stream comprises analyzing the chlorine ion content within the ballast water. In one embodiment, the step of analyzing the test stream comprises determining the oxidation/reduction potential of the ballast water which in turn, determines the required amount of halogen to meet the desired level for disinfection. In still another alternative method to analyze the test stream, the method comprises measuring total organic carbon content of the ballast water, which is then used to determine the required amount of halogen necessary to achieve the desired level for optimum disinfection.

The foregoing description is illustrative and explanatory of some embodiments of the invention, and variations in the size, shape, materials and other details will become apparent to those skilled in the art. It is intended that all such variations and modifications which fall within the scope or spirit of the appended claims be embraced thereby.

1. A method for managing ballast tank circulation comprising:
(a) treating the water within the ballast tank by adding one or more halogens in controlled amounts, the ballast tank adapted to comprise inlet and outlet piping;
(b) recirculating and pressurizing water throughout the ballast tank by means of a recirculating pump located external to the ballast tank, an inlet line to the recirculating pump tapping into the outlet pipe of the ballast tank to transport water to the recirculating pump and an outlet line from the recirculating pump to the ballast tank transports a high pressure stream of water from the pump to a location approximate the eductor;
(c) positioning one or more eductors within the ballast tank above the pressurized stream of water, the one or more eductors designed to receive a pressurized stream of water from the external recirculating pump and emit a jet of highly pressurized water circulate the water within the ballast tank thereby circulating the one or more halogens throughout the ballast tank;
(d) sampling a test stream of water from the ballast tank by removing a test sample through a sample line;
(e) analyzing the test stream to provide a chemical-related signal;
(f) sending the chemical-related signal to a controller to compare the signal to a set point indicative of the level of halogen desired within the ballast tank;
(g) determining the amount of halogen required to be added to the ballast tank;
(h) adding one or more halogens as determined in step (g) to the ballast tank; and
(i) controlling the level of the one or more halogens within the ballast tank by maintaining, increasing, or decreasing the amount of halogen added to a dosing line leading from a halogen generator to the ballast tank system.

2. The method for managing ballast tank circulation of claim 1 wherein the eductor is movable within the ballast tank.

3. The method for managing ballast tank circulation of claim 1 wherein the step of analyzing the chemical-related signal comprises analyzing the halogen ion content within the ballast water.

4. The method for managing ballast tank circulation of claim 1 wherein the step of analyzing the chemical-related signal comprises determining the oxidation/reduction potential of the ballast water.

5. The method for managing ballast tank circulation of claim 1 wherein the step of analyzing the chemical-related signal comprises measuring total organic carbon content of the ballast water.

6. The method for managing ballast tank circulation of claim 1 wherein the halogens added to the ballast tank are produced by a hypochlorite generator.

7. The method for managing ballast tank circulation of claim 1 wherein the halogens added to the ballast tank are produced by a hypochlorite electrolytic cell.

8. The method of managing ballast tank circulation of claim 1 wherein the halogens added to the ballast tank are at least one of hypochlorite, bromine and chlorine.

9. The method for managing ballast tank circulation of claim 1 further comprising supplying the halogens from a hypochlorite dosing system.

10. The method for managing ballast tank circulation of claim 1 further comprising treating the water with pH control additives, fluorides and phosphates.
